(19) United States
(12) Patent Application Publication
(10) Pub. No.: US 2025/0383098 A1
(43) Pub. Date: Dec. 18, 2025

(54) TEMPERATURE CONTROLLABLE COVERING SYSTEM AND COVERING PANEL

(71) Applicant: Lignum Technologies AG, Niederteufen (CH)

(72) Inventors: Daniel FAHLE, Dresden (DE); Uwe LIPPERT, Dresden (DE); Martin HÄDICKE, Dresden (DE)

(73) Assignee: Lignum Technologies AG, Niederteufen (CH)

(21) Appl. No.: 18/878,948

(22) PCT Filed: Jun. 29, 2022
(86) PCT No.: PCT/EP2022/067943

§ 371 Date: Dec. 26, 2024

(51) Int. Cl. F24D 13/02; E04F 15/02; F24D 3/14

(52) U.S. Cl. CPC F24D 13/024; E04F 15/02038; F24D 3/14

(57) ABSTRACT

A temperature controllable covering system comprises at least one heating and/or cooling element adapted for heating and/or cooling; a first covering panel comprising a first coupling edge extending at least partially along at least one edge of the first covering panel, and a second covering panel comprising a second coupling edge extending at least partially along at least one edge of the second covering panel. The first coupling edge and the second coupling edge are adapted to be coupled with each other. The first coupling edge and/or the second coupling edge comprise a receiving portion in which the at least one heating and/or cooling element is arrangeable. Further, in assembled condition, the at least one heating and/or cooling element at least partially extends along the at least one edge of the first covering panel and the at least one edge of the second covering panel.

### 1. TECHNICAL FIELD

The present disclosure relates to a temperature controllable covering system for floors, ceilings, or walls and to a covering panel for a temperature controllable covering system for floors, ceilings, or walls.

### 2. PRIOR ART

For heating or cooling of indoor spaces as well as outdoor surfaces, surface heatings or surface coolings are often used. For example, many users find surface heating and/or cooling more comfortable than a local cold or heat source, such as a radiator or air conditioner. In addition, surface heatings and/or surface coolings are regularly more energy efficient.

In practice, underfloor heating but also wall heating and ceiling heating are widely known. Especially in the planning of new buildings, surface heatings and/or surface coolings have been used for some time.

However, exemplarily, existing construction methods of underfloor heatings regularly require high flow temperatures of a heating medium and lead to sluggish reaction behavior due to their layer thickness. Furthermore, in the recent past underfloor heatings and other surface heatings and/or surface coolings are increasingly retrofitted in existing real estates. This is often problematic due to the extra space which is necessary e.g. for the layer thickness of the underfloor heating. For overcoming these problems, thin-bed systems such as thin-bed underfloor heating systems are regularly used in this context.

Thin-bed underfloor heating systems are usually located directly under the floor covering and regularly have a maximum installation height of up to three centimeters. Further, thin-bed underfloor heating systems can be distinguished into electric floor heating systems and hot water pipe systems.

However, said thin-bed systems but also other surface heatings and/or surface coolings have the drawback that their installation is often time-consuming and/or complicated. Moreover, the systems themselves often have a variety of drawbacks. Further details thereon are described at the example of thin-bed underfloor heating systems below.

Exemplarily, when using a wet method to install a thin-bed underfloor heating system, wet screed and/or another curable material is provided over water pipes or electric heating elements. The wet screed and/or the other curing material after drying acts as a layer between the heating and the floor covering. Thin-bed underfloor heating systems applied with a wet method require subsequent drying, allow no subsequent readjustments, and/or are limited in repairability. Further, due to the wet and hence at least partially liquid application such systems are particularly difficult to use for wall and/or ceiling applications.

Further exemplarily, when using a wet method, as above, or a dry method with system panels that are laid over and/or under the water pipes or the electric heating elements, the installation is regularly inaccurate and/or complex. This is as the worker must often freely arrange water pipes or electric heating elements in a pattern which is deemed to provide for a suitable heating and/or cooling effect. Further, in case of dry methods, the worker regularly must arrange the system panels relative to each other. In this regard, the worker additionally often has to ensure that the arrangement of the customized system panels fits the intended arrangement of the water pipes or the electric heating elements.

Even further exemplarily, the thickness of existing thin-bed underfloor heating systems is often still too high for certain applications. Particularly when surface heatings and/or surface coolings are retrofitted in existing real estates.

Thus, it is an object of the present disclosure to provide a temperature controllable covering system and a covering panel for a temperature controllable covering system that overcome the aforementioned drawbacks at least partially.

### 3. SUMMARY OF THE INVENTION

This object is achieved, at least partly, by a temperature controllable covering system and a covering panel for a temperature controllable covering system, as defined in the independent claims. Further aspects of the present disclosure are defined in the dependent claims.

Since the temperature controllable covering system and the covering panel for a temperature controllable covering system relate to temperature controllable covering systems, it will be understood that advantages and/or features of the temperature controllable covering system may also apply to the covering panel and vice versa. The present invention is particularly useful as an underfloor-system upon which the actual floor covering is arranged.

In particular, the object is achieved by a temperature controllable covering system for floors, ceilings, or walls. Hence, it is understood that the temperature controllable covering system may be provided on a floor, a ceiling, and/or a wall. The term “temperature controllable” may refer to the aspect that a temperature of the covering system may be actively increased and/or decreased. Exemplarily, the temperature of the covering system may be actively increased and/or decreased for heating and/or cooling a decorative floor, ceiling, and/or wall panel which may be provided on (over) the temperature controllable covering system.

The temperature controllable covering system comprises at least one heating and/or cooling element adapted for heating and/or cooling. The at least one heating and/or cooling element may serve to actively increase and/or decrease the temperature of the covering system. Thereby actively increasing and/or decreasing the temperature may be conducted by supplying electric energy and/or a heating/cooling medium to the at least one heating and/or cooling element.

Further, the temperature controllable covering system comprises a first covering panel comprising a first coupling edge extending at least partially along at least one edge of the first covering panel. Moreover, the temperature controllable covering system comprises a second covering panel comprising a second coupling edge extending at least partially along at least one edge of the second covering panel.

The first covering panel and/or the second covering panel may comprise a panel based on wood-based materials, plastics, and/or composite materials. Particularly, the first covering panel and/or the second covering panel may comprise a HDF board, a MDF board, a Wood-Plastic-Composite (WPC) board, a thermoplastic based board, and/or a thermoset based board.

Like known floor panels, the first covering panel and/or the second covering panel may comprise two substantially parallel longitudinal edges and two substantially parallel transverse edges. Further, it is understood that the coupling edges which extend at least partially along at least one edge of the respective covering panel may overlap with the at least one edge of the respective covering panel.

The first coupling edge and the second coupling edge are adapted to be coupled with each other. Hence, it is understood that the shape of the first coupling edge may be adapted to contact and/or engage with the shape of the second coupling edge. Thus, the first coupling edge may be adapted to be a counterpart for the second coupling edge and vice versa.

Further, the first coupling edge and/or the second coupling edge comprise a receiving portion in which the at least one heating and/or cooling element is arrangeable. The term “receiving portion” relates to the aspect that said portion is configured to receive the at least one heating and/or cooling element.

Optionally the shape of the receiving portion at least partially corresponds to the shape of the at least one heating and/or cooling element. This may enable two-dimensional contact between the receiving portion and the at least one heating and/or cooling element. Hence, a better heat or cold transfer may be achieved.

Moreover, in assembled condition, the at least one heating and/or cooling element at least partially extends along the at least one edge of the first covering panel and the at least one edge of the second covering panel. Thus, it is understood that the receiving portion may also at least partially extend along the at least one edge of the first covering panel and the at least one edge of the second covering panel.

Since the receiving portion is comprised by the first coupling edge and/or the second coupling edge the installation of the temperature controllable covering system may be facilitated and/or conducted more precisely. First, the at least one heating and/or cooling element may be precisely and/or quickly arranged as the positioning is predetermined by the receiving portion. Second, the position of the first covering panel relative to the second covering panel is predefined by the first coupling edge and the second coupling edge being adapted to be coupled with each other.

Additionally, since the receiving portion is comprised by the first coupling edge and/or the second coupling edge the thickness of the temperature controllable covering system may be reduced. Particularly when compared to systems where panels are provided above and/or under the heating and/or cooling elements.

Further, adaptions and/or repairs of the temperature controllable covering system may be conducted more easily, e.g. compared to systems which are installed by means of a wet method which relies on heating and/or cooling elements being arranged in and/or under cured material.

Moreover, as the receiving portion is comprised by the first coupling edge and/or the second coupling edge, the manufacturing effort is reduced compared to a panel where the receiving portion is not comprised by the first coupling edge and/or the second coupling edge. Exemplarily in the case when a receiving portion is provided centrally on a surface of the panel which is supposed to contact a decorative flooring layer. This is because only the edge(s) with the coupling edge(s) and hence with the receiving portion(s) need to be machined during the production of the panel.

The receiving portion may comprise a recess, wherein the recess optionally is a groove. Exemplarily, the recess may be milled and/or cut. By means of the receiving portion comprising a recess it may be avoided that an additional element for receiving and/or retaining the at least one heating and/or cooling element must be provided. Further, a groove may be particularly advantageous as it can allow for a two-dimensional contact between the receiving portion and the at least one heating and/or cooling element over longer distances, especially compared to locally arranged receiving elements which are spaced apart from each other. Thus, a more uniform heating and/or cooling may be achieved.

The receiving portion may comprise at least one retention means to retain the at least one heating and/or cooling element. Optionally the retention means is a protrusion engaging with the at least one heating and/or cooling element. The at least one retention means may allow that the at least one heating and/or cooling element is stably held within the receiving portion. Hence, the covering panels may be laid on a wall, a ceiling and/or a floor, while the at least one heating and/or cooling element is safely held in place. Further, the retention means may safely hold the at least one heating and/or cooling element in place when the system is assembled, i.e. installed. Further, it may be particularly advantageous that the retention means is a protrusion. This is as a protrusion may be integrally formed with the receiving portion, e.g. by milling and/or cutting, such that no additional element(s) must be provided.

Further, the temperature controllable covering system may comprise at least one support element. The at least one support element may be configured for being attached to the at least one heating and/or cooling element. Exemplarily, the at least one heating and/or cooling element in assembled condition may form a loop which is at least partially not in contact with the first covering panel and/or the second covering panel. The at least one support element may be attached to said loop. Thereby the at least one support element may support the decorative floor, ceiling, and/or wall panel against the floor, ceiling, and/or wall. Hence, the at least one heating and/or cooling element, i.e. the loop, may be protected. Moreover, the at least one support element may be attached to the first covering panel and/or the second covering panel. Thus, the at least one heating and/or cooling element may be precisely positioned relative to the first covering panel and/or the second covering panel. The at least one support element may comprise a clip (e.g. a plastic clip and/or a metal clip) and/or a support frame.

The receiving portion may be at least partially lined with a metal. Optionally the metal is based on aluminum, copper, and/or the like. Lining the receiving portion at least partially with a metal may enhance a two-dimensional contact between the receiving portion and the at least one heating and/or cooling element. Hence, a more uniform heating and/or cooling can be achieved. Further, the metal may enhance a thermal conductivity between the at least one heating and/or cooling element and the first covering panel and/or the second covering panel. Thus, the reaction time of the temperature controllable covering system may be reduced. The reduction of the reaction time may be particularly reduced by the metal being based on aluminum, copper, and/or the like. Further, the metal may be a bent sheet metal. Thereby, the bent sheet metal may be configured as disclosed by EP 2 813 766 A1. Particularly, the bent sheet metal may be shaped as depicted in FIGS. 1, 3, 4, and/or 5 of EP 2 813 766 A1. Further, it is understood that the receiving portion may be at least partially lined with the bent sheet metal when the temperature controllable covering system is in assembled condition.

More general, the temperature controllable covering system may comprise a heat-storing and/or a heat-conducting material (e.g. a foil) for being inserted into the receiving portion before inserting the at least one heating and/or cooling element. Thereby the advantages described in the previous paragraph apply.

The first coupling edge and the second coupling edge may jointly form the receiving portion. Exemplarily, if the receiving portion is supposed to have the shape of a circle, the first and the second covering panel may each comprise a semi-circular recess. Thus, the first coupling edge and the second coupling edge may jointly form said circle. Further exemplary, if the receiving portion is supposed to be U-shaped, the first covering panel may provide a left half of a U-shape and the second covering panel may provide a right half of the U-shape. Thus, the first coupling edge and the second coupling edge may jointly form said U-shape. In summary, the term “jointly form” may refer to the aspect that the first coupling edge and the second coupling edge each contribute to a shape of the receiving portion.

By the first coupling edge and the second coupling edge jointly forming the receiving portion, a heating or a cooling may be directly introduced into the first and second covering panel from the at least one heating and/or cooling element. Accordingly, a more uniform heating and/or cooling may be achieved. Further installing the temperature controllable covering system may be facilitated. This is as the position of the covering panels relative to each other, but also the position of the at least one heating and/or cooling element is defined by the first and second coupling edges. In other words, as soon as the positioning of the covering panels relative to each other is finished, the position of the receiving portion is also unambiguously determined.

Alternatively, the receiving portion may be completely arranged in the first coupling edge and optionally the second coupling edge at least partially closes the receiving portion in assembled condition. Exemplarily, the receiving portion in the first coupling edge may be C-shaped and configured to receive a hose and/or a tube. Accordingly, the second coupling edge may have a shape that at least partially closes the C-shape of the receiving portion, when assembled. A configuration where the receiving portion is completely arranged in the first coupling edge may be advantageous if the covering panels are to be laid while the at least one heating and/or cooling element is already installed in the first covering panel. Thereby the efficiency of installing the system may be increased.

The at least one heating and/or cooling element may be in contact with the first coupling edge and the second coupling edge in assembled condition. By the at least one heating and/or cooling element being in contact with the first coupling edge and the second coupling edge, a heating or a cooling may be directly introduced into the first and second covering panel from the at least one heating and/or cooling element. Accordingly, a more uniform heating and/or cooling may be achieved. It is understood that the at least one heating and/or cooling element may be in contact with the first coupling edge and the second coupling edge in assembled condition when the first coupling edge and the second coupling edge jointly form the receiving portion and also when the receiving portion is completely arranged in the first coupling edge and the second coupling edge partially closes the receiving portion in assembled condition.

The first coupling edge may comprise a first coupling means and the second coupling edge may comprise a second coupling means, wherein in assembled condition the first coupling means and the second coupling means overlap and couple the first coupling edge and the second coupling edge, optionally by positive locking. The overlapping may improve a heat transfer between the first covering panel and the second covering panel. Further, the positive locking may avoid that further connection means such as an adhesive are required. Exemplarily the first coupling means and the second coupling means may form a snap coupling.

Further, in assembled condition both coupling means may be arranged between the at least one heating and/or cooling element and a surface on which the temperature controllable covering system is regularly provided. Hence, the at least one heating and/or cooling element may directly provide heating and/or cooling, e.g. for a decorative panel provided above the temperature controllable covering system. Thus, the reaction time of the temperature controllable covering system may be reduced.

Alternatively, in assembled condition the heating and/or cooling element may be arranged between a surface on which the temperature controllable covering system is regularly provided and both coupling means. Hence, in other words, in assembled condition the heating and/or cooling element may be sandwiched between the surface on which the temperature controllable covering system is regularly provided and both coupling means. Thus, the overlapping coupling means may protect the at least one heating and/or cooling element. Further the overlapping coupling means may contribute to the heating and/or cooling being distributed in the first covering panel and the second covering panel before heating and/or cooling a decorative panel provided above the temperature controllable covering system. Thus, a more uniform heating and/or cooling may be achieved.

The surface on which the temperature controllable covering system is regularly provided may be a wall, a ceiling, or a floor. It is understood that the wall, the ceiling, or the floor may comprise an attached insulating and/or protecting layer attached to it.

The receiving portion may extend along a longitudinal edge and/or a transverse edge of the first covering panel and/or the second covering panel, wherein optionally the receiving portion and/or the at least one heating and/or cooling element extend along at least 50%, optionally at least 80%, and further optionally at least 90% of a length of the longitudinal edge and/or the transverse edge of the first covering panel and/or the second covering panel. The foregoing features all contribute individually to providing an areal and/or uniform heating and/or cooling by means of the temperature controllable covering system.

A cross-section of the receiving portion in a plane perpendicular to the coupling edge which comprises said receiving portion may comprise a substantially circular segment or a substantially rectangular geometry. Since the first coupling edge and/or the second coupling edge comprise the receiving portion, it is understood that the plane may be perpendicular to the first coupling edge, the second coupling edge, or the first coupling edge and the second coupling edge. The circular segment may comprise a semicircle, a quarter circle, an eighth circle and/or any other circle segment.

“Perpendicular” may be also referred to as the plane and the respective coupling edge intersecting at an angle of substantially 90 degrees. Further, the term “substantially” may refer to the aspect that the precise geometric equivalent is not required, and tolerances and minor variations may exist.

The substantially circular segment may have a radius in a range from 2.5 mm to 10 mm, further optionally from 3.5 mm to 8 mm, and even further optionally from 4.5 mm to 6.5 mm. These dimensions have proven to be advantageous for receiving heating and/or cooling elements such as hoses, tubes, and/or cables which allow for sufficient heating and/or cooling, while at the same time not having an unnecessarily increased size and/or energy consumption.

The substantially rectangular geometry may have a length which lies in the range from 10 mm to 25 mm, and further optionally a width which lies in the range from 0.2 mm to 5 mm. These dimensions have proven to be advantageous for receiving heating and/or cooling elements such as heating foils and/or heating cables which allow for sufficient heating and/or cooling, while at the same time not having an unnecessarily increased size and/or energy consumption.

In assembled condition the at least one heating and/or cooling element may counteract a separation of the first covering panel and the second covering panel. Thereby, the heating and/or cooling element optionally exerts a force on the first covering panel and the second covering panel which counteracts the separation of the first covering panel and the second covering panel. For achieving that the at least one heating and/or cooling element counteracts a separation of the first covering panel and the second covering panel the person skilled in the art may identify different solutions. In the following three of them are briefly introduced.

According to a first example the first coupling edge and the second coupling edge jointly form the receiving portion (e.g. a U-shape), wherein in assembled condition both coupling means are arranged between the receiving portion with the at least one heating and/or cooling element and a surface on which the temperature controllable covering system is regularly provided. Hence, if the coupling means require for being uncoupled that at least one of the first covering panel or the second covering panel is tilted upwards in a direction away from the surface on which the temperature controllable covering system is regularly provided, the at least one heating and/or cooling element may counteract a separation of the first covering panel and the second covering panel.

According to a second example, the heating and/or cooling element blocks and/or presses an element of the coupling means (e.g. a spring element) such that the connection of the coupling means is enforced. It is understood that said pressing may be achieved by an elasticity of the heating and/or cooling element.

According to a third example, the heating and/or cooling element may counteract a separation of the first covering panel and the second covering panel, when the at least one heating and/or cooling element is in adhesive contact with the first coupling edge and the second coupling edge.

The at least one heating and/or cooling element may comprise a hose and/or a tube for guiding a heating and/or cooling medium, wherein optionally the at least one heating and/or cooling element has an outer diameter in a range from 5 mm to 20 mm, further optionally from 7 mm to 16 mm, and even further optionally from 9 mm to 13 mm. The heating and/or cooling medium may comprise a fluid such as water, oil, and/or the like. Further, said dimensions allow for sufficient heating and/or cooling, while at the same time not unnecessarily increasing size and/or energy consumption.

The at least one heating and/or cooling element may comprise an electric heating element, wherein optionally the electric heating element comprises a heating foil and/or heating cable, wherein further optionally the electric heating element has a substantially rectangular geometry, optionally with a length which lies in the range from 10 mm to 25 mm, and further optionally with a width which lies in the range from 0.2 mm to 5 mm. Further, said dimensions allow for sufficient heating and/or cooling, while at the same time not unnecessarily increasing size and/or energy consumption.

In assembled condition the heating and/or cooling element may be compressed between the first covering panel and the second covering panel such that a portion of the at least one heating and/or cooling element is urged into a direction opposite to the surface on which the temperature controllable covering system is regularly provided. Hence, a contact between the at least one heating and/or cooling element and a decorative covering panel provided on the temperature controllable covering system may be increased, e.g. by means of surface pressure between the at least one heating and/or cooling element and the decorative covering panel.

The at least one heating and/or cooling element, the first covering panel, and the second covering panel may be assembled. Thereby optionally the first covering panel, and the second covering panel are arranged on a floor, a ceiling, or a wall. When assembled, the first coupling edge and the second coupling edge are coupled with each other. Further, when assembled, the at least one heating and/or cooling element is arranged in the receiving portion. Moreover, in assembled condition, the at least one heating and/or cooling element at least partially extends along the at least one edge of the first covering panel and the at least one edge of the second covering panel.

Further, in assembled state, at least one decorative covering panel may be arranged on the first covering panel and/or the second covering panel. Thus, the temperature controllable covering system may provide heating and/or cooling for the at least one decorative covering panel.

The object may be also achieved by a covering panel for a temperature controllable covering system for floors, ceilings, or walls, optionally for the temperature controllable covering system according to one of the preceding claims. It is understood that features and/or advantages which are described above regarding the temperature controllable covering system may also apply for the covering panel. Particularly, the covering panel may be configured as the first covering panel and/or the second covering panel as described above.

The covering panel comprises a coupling edge extending at least partially along at least one edge of the covering panel, wherein the coupling edge is configured for being coupled with a coupling edge of a further covering panel. The coupling edge may be configured as the first coupling edge and/or the second coupling edge of the temperature controllable covering system as described above.

The coupling edge comprises a receiving portion for at least partially receiving at least one heating and/or cooling element, and a coupling means, for establishing a positive locking with a coupling means of the further covering panel. The receiving portion may be configured as the receiving portion of the temperature controllable covering system as described above. Moreover, the coupling means may be configured as the first coupling means and/or the second coupling means of the temperature controllable covering system as described above.

The receiving portion may extend along a longitudinal edge and/or a transverse edge of the covering panel. Optionally the at least one receiving portion extends along at least 50%, further optionally at least 80%, and even further optionally at least 90% of a length of the longitudinal edge and/or the transverse edge. It is noted that respective advantages for these features are provided above with regards to the temperature controllable covering system.

A cross-section of the receiving portion in a plane perpendicular to the coupling edge which comprises said receiving portion may comprise a substantially circular segment or a substantially rectangular geometry. The circular segment may comprise a semicircle, a quarter circle, an eighth circle and/or any other circle segment.

“Perpendicular” may be also referred to as the plane and the coupling edge intersecting at an angle of substantially 90 degrees. Further, the term “substantially” may refer to the aspect that the precise geometric equivalent is not required, and tolerances and minor variations may exist.

The substantially circular segment may have a radius in a range from 2.5 mm to 10 mm, further optionally from 3.5 mm to 8 mm, and even further optionally from 4.5 mm to 6.5 mm. These dimensions have proven to be advantageous for receiving heating and/or cooling elements such as hoses and/or tubes which allow for sufficient heating and/or cooling, while at the same time not having an unnecessarily increased size and/or energy consumption.

The substantially rectangular geometry may have a length which lies in the range from 10 mm to 25 mm, and further optionally a width which lies in the range from 0.2 mm to 5 mm. These dimensions have proven to be advantageous for receiving heating and/or cooling elements such as heating foils and/or heating cables which allow for sufficient heating and/or cooling, while at the same time not having an unnecessarily increased size and/or energy consumption.

The receiving portion may comprise at least one retention means for retaining the at least one heating and/or cooling element, wherein optionally the retention means is a protrusion configured to engage with the at least one heating and/or cooling element. The at least one retention means may be configured as the at least one retention means of the temperature controllable covering system as described above.

The receiving portion may be at least partially lined with a metal. Optionally the metal is based on aluminum, copper, and/or the like. Further details on this specification and the respective advantages are provided above with regards to the temperature controllable covering system.

The coupling means may be arranged between the receiving portion and a surface on which the covering panel is regularly provided. Alternatively, the receiving portion may be arranged between a surface on which the covering panel is regularly provided and the coupling means. Further details on this specification and the respective advantages are provided above with regards to the temperature controllable covering system.

### 4. BRIEF DESCRIPTION OF THE ACCOMPANYING FIGURES

In the following, the accompanying figures are briefly described:

FIG. 1 shows, a cross-section of a first temperature controllable covering system according to the present invention, wherein a coupling of longitudinal edges of two covering panels is illustrated;

FIG. 2 shows, a cross-section of a second temperature controllable covering system according to the present invention, wherein a coupling of longitudinal edges of two covering panels is illustrated;

FIG. 3 shows, a cross-section of a third temperature controllable covering system according to the present invention, wherein a coupling of longitudinal edges of two covering panels is illustrated;

FIG. 4 shows, a cross-section of a fourth temperature controllable covering system according to the present invention, wherein a coupling of longitudinal edges of two covering panels is illustrated;

FIG. 5 shows, a cross-section of a fifth temperature controllable covering system according to the present invention, wherein a coupling of longitudinal edges of two covering panels is illustrated, and

FIG. 6 schematically shows the first temperature controllable covering system of FIG. 1 in a top view.

### 5. DETAILED DESCRIPTION OF THE FIGURES

Each of the FIGS. 1, 2, 3, 4, 5 depicts a temperature controllable covering system 10; 11; 12; 13; 14 for floors, ceilings, or walls. In each of FIGS. 1 to 5 the temperature controllable covering system 10; 11; 12; 13; 14 is in an assembled state.

Each of the FIGS. 1, 2, 3, 4, 5 shows a cross-section of the respective temperature controllable covering system 10; 11; 12; 13; 14 such that a coupling of longitudinal edges of two covering panels is illustrated. However, it is understood that each of the FIGS. 1, 2, 3, 4, 5 may also show a coupling of transverse edges of two covering panels.

Each of the temperature controllable covering systems 10; 11; 12; 13; 14 comprises a heating and/or cooling element 20; 21; 22; 23; 24 adapted for heating and/or cooling.

Further, each of the depicted temperature controllable covering systems 10; 11; 12; 13; 14 comprises a first covering panel 30; 31; 32; 33; 34 comprising a first coupling edge 50; 51; 52; 53; 54 extending at least partially along a longitudinal edge and a transverse edge of the first covering panel 30; 31; 32; 33; 34, and a second covering panel 40; 41; 42; 43; 44 comprising a second coupling edge 60; 61; 62; 63; 64 extending at least partially along a longitudinal edge and a transverse edge of the second covering panel 40; 41; 42; 43; 44.

As further illustrated in all FIGS. 1 to 5, the first coupling edge 50; 51; 52; 53; 54 and the second coupling edge 60; 61; 62; 63; 64 are coupled with each other. Thereby the first coupling edge 50; 51; 52; 53; 54 and/or the second coupling edge 60; 61; 62; 63; 64 comprise a receiving portion 70; 71; 72; 73; 74 in which the at least one heating and/or cooling element 20; 21; 22; 23; 24 is arrangeable, and wherein the at least one heating and/or cooling element 20; 21; 22; 23; 24 at least partially extends along the at least one edge of the first covering panel 30; 31; 32; 33; 34 and the at least one edge of the second covering panel 40; 41; 42; 43; 44.

Moreover, as illustrated in all FIGS. 1 to 5, the receiving portions 70; 71; 72; 73; 74 of all temperature controllable covering systems 10; 11; 12; 13; 14 comprises a recess. Thereby the recess of the of FIGS. 1, 2, 3, and 5 also is a groove.

Further, as can be seen from FIGS. 1, 2, and 5, the receiving portions 70; 71; 74 of the temperature controllable covering systems 10; 11; 14 each comprise at least one retention means 80; 81; 84 to retain the at least one heating and/or cooling element 20; 21; 24. Thereby the retention means 80; 81; 84 is a protrusion engaging with the at least one heating and/or cooling element 20; 21; 24.

Furthermore, as illustrated in FIGS. 1, 4, and 5 for the temperature controllable covering systems 10; 13; 14, the first coupling edge 50; 53; 54 and the second coupling edge 60; 63; 64 jointly form the receiving portion 70; 73; 74.

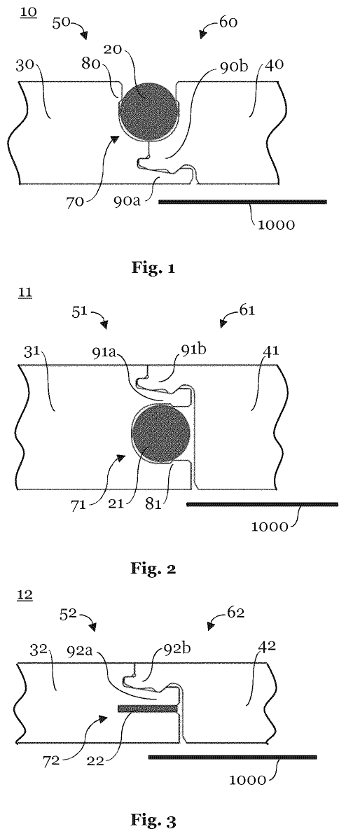

On the other hand, as illustrated in FIGS. 2 and 3 for the temperature controllable covering systems 11; 12, the receiving portion 71; 72 is completely arranged in the first coupling edge 51; 52, wherein the second coupling edge 61; 62 closes the receiving portion 71; 72.

Further, as illustrated in FIGS. 1, 4, and 5 for the temperature controllable covering systems 10; 13; 14, the at least one heating and/or cooling element 20; 23; 24 is in contact with the first coupling edge 50; 53; 54 and the second coupling edge 60; 63; 64 in assembled condition.

Further, in each of the temperature controllable covering systems 10; 11; 12; 13; 14 depicted in FIGS. 1 to 5 the first coupling edge 50; 51; 52; 53; 54 comprises a first coupling means 90a; 91a; 92a; 93a; 94a and the second coupling edge 60; 61; 62; 63; 64 comprises a second coupling means 90b; 91b; 92b; 93b; 94b, wherein the first coupling means 90a; 91a; 92a; 93a; 94a and the second coupling means 90b; 91b; 92b; 93b; 94b overlap and couple the first coupling edge 50; 51; 52; 53; 54 and the second coupling edge 60; 61; 62; 63; 64 by positive locking.

In this regard, in FIGS. 1, 4, and 5, both coupling means 90a, 90b; 93a, 93b; 94a, 94b are arranged between the at least one heating and/or cooling element 20; 23; 24 and a surface 1000 on which the temperature controllable covering system 10; 13; 14 is regularly provided.

Alternatively, and further in this regard, in FIGS. 2 and 3, the heating and/or cooling element 21; 22 is arranged between a surface 1000 on which the temperature controllable covering system 11; 12 is regularly provided and both coupling means 91a, 91b; 92a, 92b.

Furthermore, in each of the temperature controllable covering systems 10; 11; 12; 13; 14 depicted in FIGS. 1 to 5, the receiving portion 70; 71; 72; 73; 74 extends along a longitudinal edge and a transverse edge of the first covering panel 30; 31; 32; 33; 34 and the second covering panel 40; 41; 42; 43; 44.

As can be seen in each of the temperature controllable covering systems 10; 11; 14 depicted in FIGS. 1, 2, and 5, a cross-section of the receiving portion 70; 71; 74 in a plane perpendicular to the coupling edge which comprises said receiving portion 70; 71; 74 comprises a substantially circular segment. Hence, the heating and/or cooling element 20; 21; 24 may be a hose and/or a tube for guiding a heating and/or cooling medium. However, the heating and/or cooling element 20; 21; 24 may also be an electric heating element, namely a heating cable.

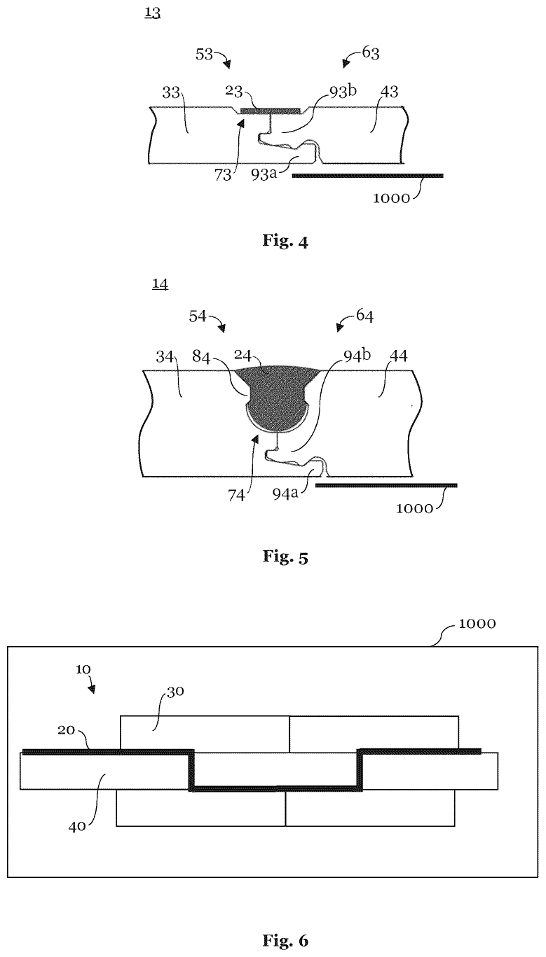

As can be seen in each of the temperature controllable covering systems 12; 13 depicted in FIGS. 3 and 4, a cross-section of the receiving portion 72; 73 in a plane perpendicular to the coupling edge which comprises said receiving portion 72; 73 comprises a substantially rectangular geometry. Hence, the heating and/or cooling element 22; 23 may be an electric heating element comprising a heating foil and/or heating cable, wherein the electric heating element has a substantially rectangular geometry.

Furthermore, as can be seen in each of the temperature controllable covering systems 10; 11; 12; 13; 14 depicted in FIGS. 1, 2, 3, 4, and 5, the at least one heating and/or cooling element 20; 21; 22; 23; 24 counteracts a separation of the first covering panel 30; 31; 32; 33; 34 and the second covering panel 40; 41; 42; 43; 44. Further, at least in FIG. 5 the compressed heating and/or cooling element 24 even exerts a force on the first covering panel 34 and the second covering panel 44 which counteracts the separation of the first covering panel 34 and the second covering panel 44.

In FIGS. 1 and 5 the separation of the first covering panel 30; 34 and the second covering panel 40; 44 is counteracted in that the coupling means 90a, 90b; 94a, 94b require for being uncoupled that at least one of the first covering panel 30; 34 or the second covering panel 40; 44 is tilted upwards in a direction away from the surface 1000 on which the temperature controllable covering system is provided, what is at least partially avoided by the at least one heating and/or cooling element 20; 24.

In FIGS. 2 and 3 the separation of the first covering panel 31; 32 and the second covering panel 41; 42 is counteracted in that the heating and/or cooling element 21; 22 blocks and/or presses an element 91a; 92a of the coupling means such that the connection of the coupling means 91a, 91b; 92a, 92b is enforced.

As it is illustrated in the temperature controllable covering system 14 of FIG. 4, the heating and/or cooling element 24 is compressed between the first covering panel 34 and the second covering panel 44 such that a portion of the at least one heating and/or cooling element 24 is urged into a direction opposite to the surface 1000 on which the temperature controllable covering system 14 is regularly provided.

As will be understood, a decorative covering panel may be arranged on the first covering panel 30; 31; 32; 33; 34 and/or the second covering panel 40; 41; 42; 43; 44 in any one of the temperature controllable covering systems 10; 11; 12; 13; 14 depicted in FIGS. 1 to 5.

In FIGS. 1, 2, 3, 4, and 5 a covering panel 30, 40; 31; 32; 33, 43; 34, 44 for a temperature controllable covering system for floors, ceilings, or walls, according to the present invention is depicted.

Further, FIG. 6 shows the first temperature controllable covering system 10 being provided on the surface 1000 which may be a wall, a ceiling, or a floor in a top view. As illustrated, the temperature controllable covering system 10 is part of a floor, ceiling, or wall covering which comprises a plurality of covering panels. It will be understood that decorative covering panels may be arranged over the plurality of covering panels which comprise the covering panels 30, 40. Further, regarding FIG. 1 it was described above that the coupling of longitudinal edges of two covering panels 30, 40 is illustrated. This corresponds with the arrangement of the covering panels 30, 40 depicted in FIG. 6. However, it will be also understood from FIG. 6 that the cross-section of the temperature controllable covering system 10 provided in FIG. 1 may exemplarily also apply for the transverse edge of the second covering panel 40 along which the heating and/or cooling element 20 also extends. Regarding FIG. 6 it is understood that the depicted arrangement may be difficult to implement for a heating and/or cooling element with a higher stiffness. This is as the bending radii may be too small for such a heating and/or cooling element. This problem may be overcome by adapting the arrangement of the panels. Moreover, the arrangement of the heating and/or cooling element may be adapted. Exemplarily, the heating and/or cooling element may form a loop which is at least partially not in contact with the covering panels. Further, the receiving portions may be adapted to allow for larger bending radii, e.g. by rounded edges.

### LIST OF REFERENCE SIGNS

10; 11; 12; 13; 14 temperature controllable covering system
20; 21; 22; 23; 24 heating and/or cooling element
30; 31; 32; 33; 34 first covering panel
40; 41; 42; 43; 44 second covering panel
50; 51; 52; 53; 54 first coupling edge
60; 61; 62; 63; 64 second coupling edge
70; 71; 72; 73; 74 receiving portion
80; 81; 84 retention means
90a; 91a; 92a; 93a; 94a first coupling means
90b; 91b; 92b; 93b; 94b second coupling means
1000 surface on which the temperature controllable covering system is provided

1. A temperature controllable covering system for floors, ceilings, or walls, comprising:
at least one heating and/or cooling element adapted for heating and/or cooling;
a first covering panel comprising a first coupling edge extending at least partially along at least one edge of the first covering panel, and
a second covering panel comprising a second coupling edge extending at least partially along at least one edge of the second covering panel, wherein
the first coupling edge and the second coupling edge are adapted to be coupled with each other, wherein
the first coupling edge and/or the second coupling edge comprise a receiving portion in which the at least one heating and/or cooling element is arrangeable, and wherein in assembled condition, the at least one heating and/or cooling element at least partially extends along the at least one edge of the first covering panel and the at least one edge of the second covering panel.

2. The temperature controllable covering according to claim 1, wherein the receiving portion comprises a recess, wherein the recess optionally is a groove.

3. The temperature controllable covering system according to claim 1, wherein the receiving portion comprises at least one retention means to retain the at least one heating and/or cooling element, wherein optionally the retention means is a protrusion engaging with the at least one heating and/or cooling element.

4. The temperature controllable covering system according to claim 1, wherein the receiving portion is at least partially lined with a metal, wherein optionally the metal is based on aluminum.

5. The temperature controllable covering system according to claim 1, wherein
the first coupling edge and the second coupling edge jointly form the receiving portion, or wherein
the receiving portion is completely arranged in the first coupling edge and optionally the second coupling edge at least partially closes the receiving portion in assembled condition.

6. The temperature controllable covering system according to claim 1, wherein the at least one heating and/or cooling element is in contact with the first coupling edge and the second coupling edge in assembled condition.

7. The temperature controllable covering system according to claim 1, wherein the first coupling edge comprises a first coupling means and the second coupling edge comprises a second coupling means, wherein in assembled condition the first coupling means and the second coupling means overlap and couple the first coupling edge and the second coupling edge, optionally by positive locking.

8. The temperature controllable covering system according to claim 7, wherein
in assembled condition both coupling means are arranged between the at least one heating and/or cooling element and a surface on which the temperature controllable covering system is regularly provided, or wherein
in assembled condition the heating and/or cooling element is arranged between a surface on which the temperature controllable covering system is regularly provided and both coupling means.

9. The temperature controllable covering system according to claim 1, wherein the receiving portion extends along a longitudinal edge and/or a transverse edge of the first covering panel and/or the second covering panel, wherein optionally the receiving portion and/or the at least one heating and/or cooling element extend along at least 50%, optionally at least 80%, and further optionally at least 90% of a length of the longitudinal edge and/or the transverse edge of the first covering panel and/or the second covering panel.

10. The temperature controllable covering system according to claim 1, wherein a cross-section of the receiving portion in a plane perpendicular to the coupling edge which comprises said receiving portion comprises
a substantially circular segment, optionally with a radius in a range from 2.5 mm to 10 mm, further optionally from 3.5 mm to 8 mm, and even further optionally from 4.5mm to 6.5 mm, or
a substantially rectangular geometry, optionally with a length which lies in the range from 10 mm to 25 mm, and further optionally with a width which lies in the range from 0.2 mm to 5 mm.

11. The temperature controllable covering system according to claim 1, wherein in assembled condition the at least one heating and/or cooling element counteracts a separation of the first covering panel and the second covering panel, whereby the heating and/or cooling element optionally exerts a force on the first covering panel and the second covering panel which counteracts the separation of the first covering panel and the second covering panel.

12. The temperature controllable covering system according to claim 1, wherein the at least one heating and/or cooling element comprises a hose and/or a tube for guiding a heating and/or cooling medium, wherein optionally the at least one heating and/or cooling element has an outer diameter in a range from 5 mm to 20 mm, further optionally from 7 mm to 16 mm, and even further optionally from 9 mm to 13 mm.

13. The temperature controllable covering system to claim 1, wherein the at least one heating and/or cooling element comprises an electric heating element, wherein optionally the electric heating element comprises a heating foil and/or heating cable, wherein further optionally the electric heating element has a substantially rectangular geometry, optionally with a length which lies in the range from 10 mm to 25 mm, and further optionally with a width which lies in the range from 0.2 mm to 5 mm.

14. The temperature controllable covering system according to claim 1, wherein in assembled condition the heating and/or cooling element is compressed between the first covering panel and the second covering panel such that a portion of the at least one heating and/or cooling element is urged into a direction opposite to the surface on which the temperature controllable covering system is regularly provided.

15. The temperature controllable covering system according to claim 1, wherein the at least one heating and/or cooling element, the first covering panel, and the second covering panel are assembled, wherein optionally the first covering panel, and the second covering panel are arranged on a floor, a ceiling, or a wall.

16. The temperature controllable covering according to claim 15, wherein at least one decorative covering panel is arranged on the first covering panel and/or the second covering panel.

17. A covering panel for a temperature controllable covering system for floors, ceilings, or walls, optionally for the temperature controllable covering system according to claim 1, the covering panel comprising
a coupling edge extending at least partially along at least one edge of the covering panel, wherein the coupling edge is configured for being coupled with a coupling edge of a further covering panel, wherein the coupling edge comprises
a receiving portion for at least partially receiving at least one heating and/or cooling element, and
a coupling means, for establishing a positive locking with a coupling means of the further covering panel.

18. The covering panel according to claim 17, wherein the receiving portion extends along a longitudinal edge and/or a transverse edge of the covering panel, wherein optionally the at least one receiving portion extends along at least 50%, optionally at least 80%, and further optionally at least 90% of a length of the longitudinal edge and/or the transverse edge.

19. The covering panel according to claim 17, wherein a cross-section of the receiving portion in a plane perpendicular to the coupling edge which comprises said receiving portion comprises
a substantially circular segment, optionally with a radius in a range from 2.5 mm to 10 mm, further optionally from 3.5 mm to 8 mm, and even further optionally from 4.5 mm to 6.5 mm, or
a substantially rectangular geometry, optionally with a length which lies in the range from 10 mm to 25 mm, and further optionally with a width which lies in the range from 0.2 mm to 5 mm.

20. The covering panel according to one of claim 17, wherein the receiving portion comprises at least one retention means for retaining the at least one heating and/or cooling element, wherein optionally the retention means is a protrusion configured to engage with the at least one heating and/or cooling element.

21. The covering panel according to claim 17, wherein the receiving portion is at least partially lined with a metal, wherein optionally the metal is based on aluminum.

22. The covering panel according to claim 17, wherein
the coupling means is arranged between the receiving portion and a surface on which the covering panel is regularly provided, or wherein
the receiving portion is arranged between a surface on which the covering panel is regularly provided and the coupling means.
